(19) United States
(12) Patent Application Publication
(10) Pub. No.: US 2003/0115757 A1
(43) Pub. Date: Jun. 26, 2003

(54) Method and equipment for stripping a flat cable

(76) Inventors: Claudio Meisser, Cham (CH); Franz Fommenwiler, Rothenburg (CH)

Correspondence Address: MACMILLAN SOBANSKI & TODD, LLC, ONE MARITIME PLAZA FOURTH FLOOR, 720 WATER STREET, TOLEDO, OH, 43604-1619, US

(21) Appl. No.: 10/281,674

(22) Filed: Oct. 28, 2002

(30) Foreign Application Priority Data
Oct. 26, 2001 (EP) 01811049.4

(51) Int. Cl. B26D 1/00; B26D 3/00

(52) U.S. Cl. 30/116; 83/34

(57) ABSTRACT

A cable stripping equipment and method for exposing conductors of a flat cable transports the cable in a transport direction with first and second cable advancing devices positioned on opposite side of a cutting station having a cutting unit movable in x, y and z directions. During the cutting process, the flat cable is tensioned by the cable advancing devices. A measuring wheel detects the movement of the flat cable which movement is converted by an encoder into an electrical signal to coordinate with the cutting unit. The flat cable is guided on both sides of the cutting station by an adjustable cable guide positioned at the front edge of the cable.

### BACKGROUND OF THE INVENTION

The present invention relates to a method and equipment for stripping a flat cable having conductors embedded in insulation, wherein the stripping process is carried out mechanically.

Stripping equipment for exposing conductors of a flat cable is shown in the EP Patent Application 1 124 297, the equipment essentially consisting of a vacuum table, a table drive, a cutter drive and an advancing drive which is arranged on a carriage and which moves the cutter drive together with the cutter on the carriage. The carriage is guided by means of guide rails arranged at a housing table. The housing table is supported by a housing, at which the table drive is also arranged. The advancing drive is moved by means of a pinion along a rack arranged at the housing and executes the movement of the carriage. The height-adjustable vacuum table is controlled in dependence on the advancing drive and in dependence on detection of a conductor to be exposed.

A disadvantage of this known equipment is that due to the upward and downward movement of the vacuum table the entire cutting process is relatively slow. Moreover, closely adjacent conductors cannot be individually exposed sufficiently precisely by the roller cutter. Flat cables with conductors exposed at one side can be connected merely by means of ultrasound welding, wherein the insulation has to be penetrated for the welding process.

### SUMMARY OF THE INVENTION

The present invention meets the object of avoiding the disadvantages of the known equipment and proposes a method and equipment by means of which the conductors of a flat cable can be exposed in accurate manner.

The advantages achieved by the apparatus and method according to the present invention are essentially to be seen in that the cutting process needs less time. In addition, finer degrees of cutting are possible, wherein slightly offset cuts can also be made in the cable longitudinal axis without displacing the flat cable. This is achieved by a face cutter which is movable in the x, y and z directions. Moreover, the conductors can be exposed not only from one side or from above, but also from the other side or from below. Cutting through individual conductors or the formation of passages in the flat cable can equally well be carried out. Flat cables with conductors exposed at two sides can be connected by means of resistance welding, wherein a cleaner and more secure contact-making is producible.

### DESCRIPTION OF THE DRAWINGS

The above, as well as other advantages of the present invention, will become readily apparent to those skilled in the art from the following detailed description of a preferred embodiment when considered in the light of the accompanying drawings in which:

FIG. 1 is a perspective view of a flat cable with conductors exposed at the cable ends over the entire cable width and with cuts in the longitudinal direction and a passage in transverse direction in accordance with the present invention;

FIG. 2 is a perspective view of the flat cable shown in FIG. 1 in conjunction with a further flat cable, wherein the exposed conductors are connected together;

FIG. 3 is a cross-section of the flat cable shown in FIG. 1 with a conductor exposed at one side and a conductor cut through at one side;

FIG. 4 is a cross-section of the flat cable shown in FIG. 1 with a conductor exposed at both sides and a passage produced at both sides;

FIG. 5 is a perspective view of stripping equipment according to the present invention for exposing the conductors at the upper side of the flat cable;

FIG. 6 is a perspective view of stripping equipment according to the present invention for exposing the conductors at the upper side and at the underside of the flat cable;

FIG. 7 is a perspective view of an upper z-module and a lower z-module each with a respective cutting unit for exposing the conductors at the upper side or at the underside of the flat cable;

FIG. 8 is a perspective view an upper cutting head of the upper cutting unit and a lower cutting head of the lower cutting unit;

FIG. 9 is a fragmentary perspective view of a cutter of the upper cutting head and a punch of the lower cutting head;

FIG. 10 is a perspective view of a cutting unit with a cutter and a punch; and

FIG. 11 is a perspective view of a variant of the embodiment of the cutting unit with a cutter and a punch shown in FIG. 10.

### DESCRIPTION OF THE PREFERRED EMBODIMENT

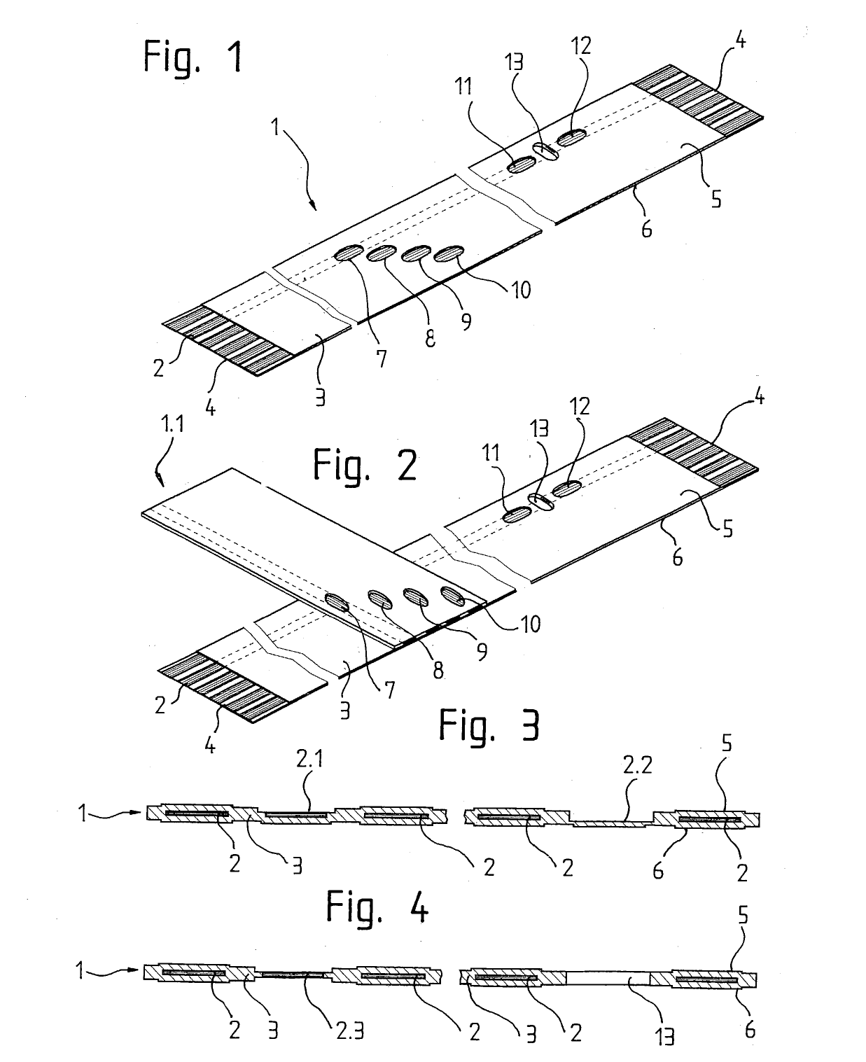

FIGS. 1 to 4 show a flat cable 1 having a plurality of flat electrical conductors 2 that extend in parallel in a longitudinal direction and which are embedded in insulation material 3. FIG. 1 shows the flat cable 1 with the conductors 2 exposed at cable ends 4 over the entire cable width at an upper side 5 of the cable. Moreover, several of the conductors 2 have been exposed in the cable longitudinal direction by slightly offset cuts or strip areas 7, 8, 9 and 10 and one conductor 2 has been exposed by two further cuts or strip areas 11 and 12, wherein the one conductor 2 has been interrupted between the two cuts 11 and 12 by a cable passage 13 extending through the cable.

FIG. 2 shows the flat cable 1 with the conductors 2 exposed at the cable ends 4 over the entire cable width at the upper side 5 and at an underside 6. The flat cable 1 is connected with another flat cable 1.1 also having the cuts 7, 8, 9 and 10, wherein the conductors 2 exposed at each cable by means of the cuts 7, 8, 9 and 10 are connected together.

FIG. 3 shows a cross-section of the flat cable 1 with a conductor 2.1 exposed from the upper side 5 and a conductor 2.2 cut through from the upper side 5.

FIG. 4 shows a cross-section of the flat cable 1 with a conductor 2.3 exposed from the upper side 5 and from the underside 6 and with the passage 13 extending between the sides.

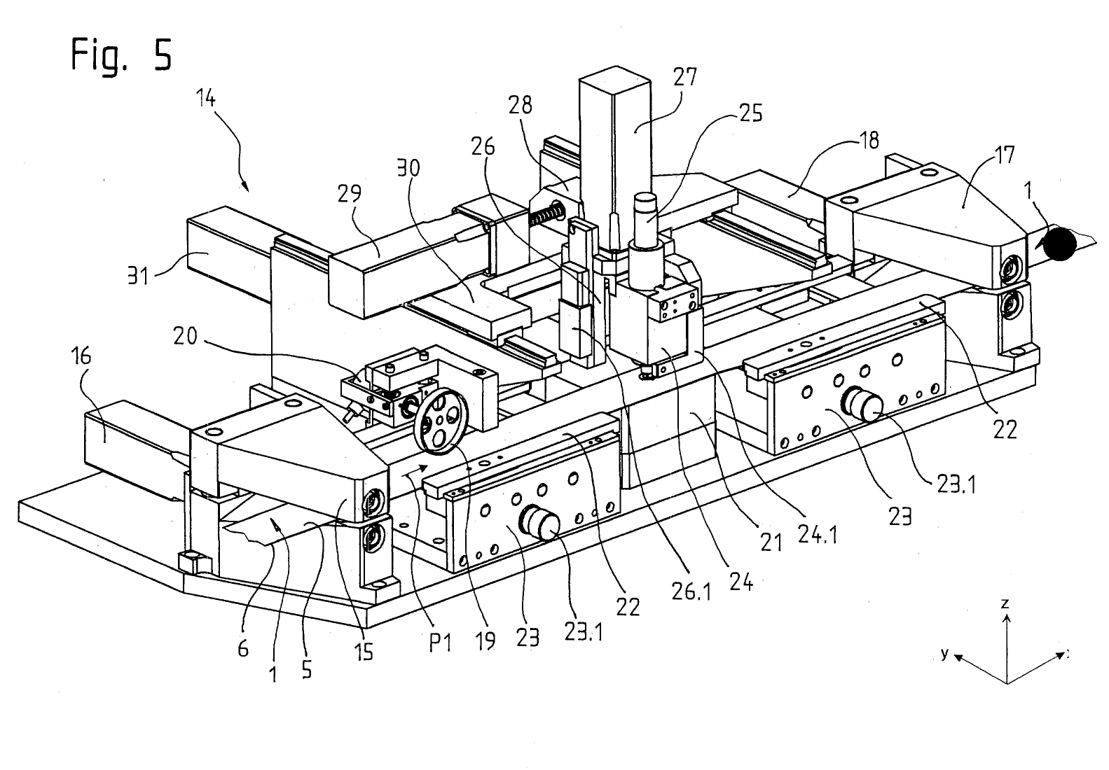

FIG. 5 shows a stripping equipment 14 according to the present invention for exposing the conductors 2 at the upper side 5 of the flat cable 1. The flat cable 1 is transported by means of a first cable advancing device 15 with a drive 16, positioned to a left side of a central stripping station or cutting area, and by means of a second cable advancing device 17 with a drive 18 positioned to a right side of the central stripping station. The transport direction is symbolized by an arrow P1. During the cutting process the flat cable 1 is at rest and is tensioned by means of the cable advancing devices 15 and 17. At least one brake roller can be provided instead of the first cable advancing device 15 with the drive 16. A measuring wheel 19 detects the movement of the flat cable 1, wherein the movement of the measuring wheel 19 is converted by means of an encoder 20 into an electrical signal for coordination of the operation of the cutting operation. The flat cable 1 is guided at both sides of the central stripping station by a cable guide 22, adjustable by means of an adjusting device 23 with a handwheel 23.1. The cable guide 22 extends in a longitudinal direction at the front edge of the cable 1 on both sides of a cutting table 21 located below the cable at the stripping station. The adjusting device 23 can also be settable by a motor drive.

A cutting unit 24 is positioned above the cable 1 and the cutting table 21 at the stripping station. The cutting unit 24 has a cable holder 24.1 and a drive 25 is movable in “x”, “y” and “z” directions. For that purpose the cutting unit 24 together with the drive 25 is arranged at a z-module 26 with a drive 27. The z-module 26 with the drive 27 is arranged at an x-module 28 with a drive 29. The x-module 28 with the drive 29 is arranged at a y-module 30 with a drive 31.

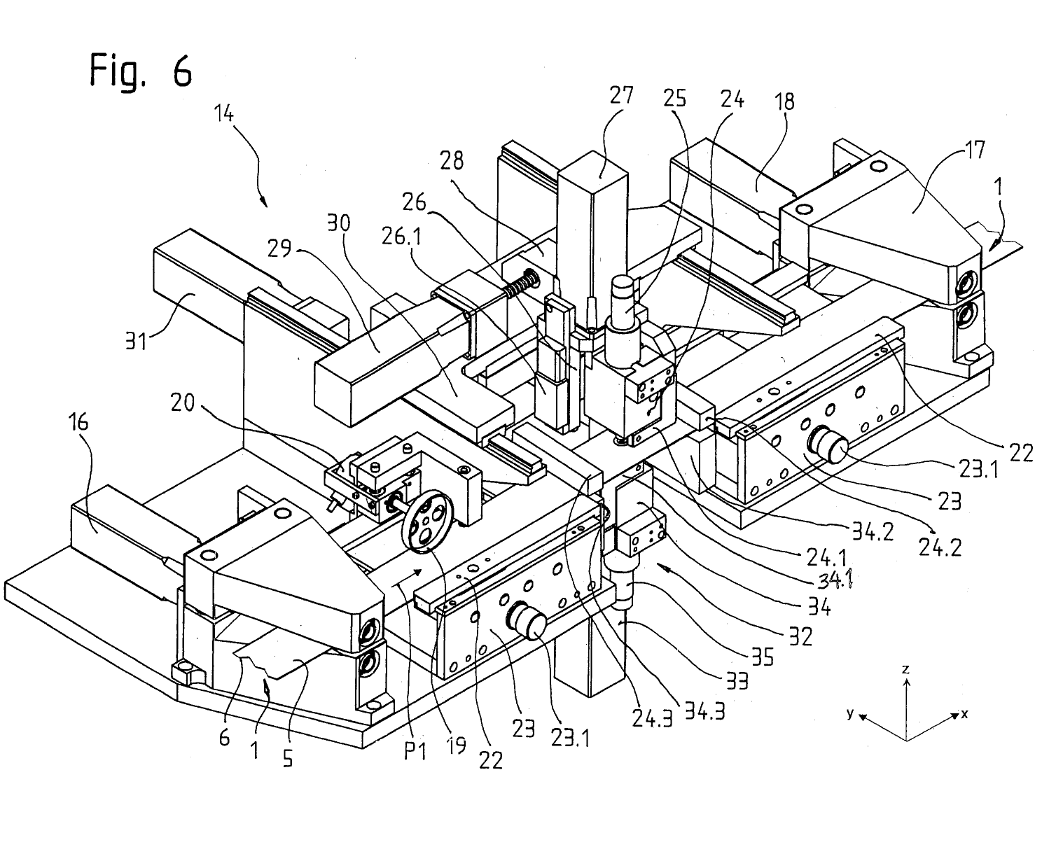

FIG. 6 shows the stripping equipment 14 modified for exposing the conductors 2 at the upper side 5 and at the underside 6 of the flat cable 1. Instead of the cutting table 21 shown in FIG. 5, there is provided a further or a lower z-module 32 with a drive 33, wherein a further cutting unit 34 with a cable holder 34.1 and a drive 35 is arranged at the z-module 32. The flat cable 1 can be processed from the underside 6 by the further cutting unit 34. Cable holders 24.2, 24.3, 34.2 and 34.3 which are, for example, pneumatic are provided at both sides of the cutting units 24 and 34.

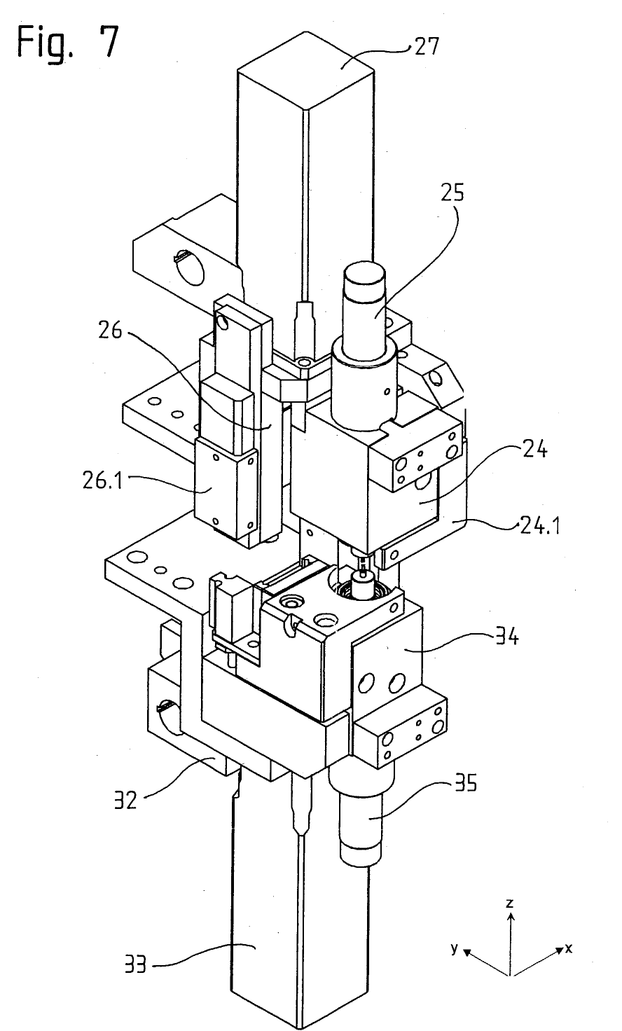

FIG. 7 shows the upper z-module 26 with the cutting unit 24 and the lower z-module 32 with the cutting unit 34 for exposing the conductors 2 at the upper side 5 and at the underside 6, respectively, of the flat cable 1. The z-modules 26 and 32 moving the cutting units 24 and 34 respectively in a vertical direction can each be arranged at a respective x-module or arranged at a common x-module. The movement of the upper cutting unit 24 in the “z” direction is measured by means of a scale 26.1. The movement of the lower cutting unit 34 in the “z” direction is measured by means of a scale, which is not visible.

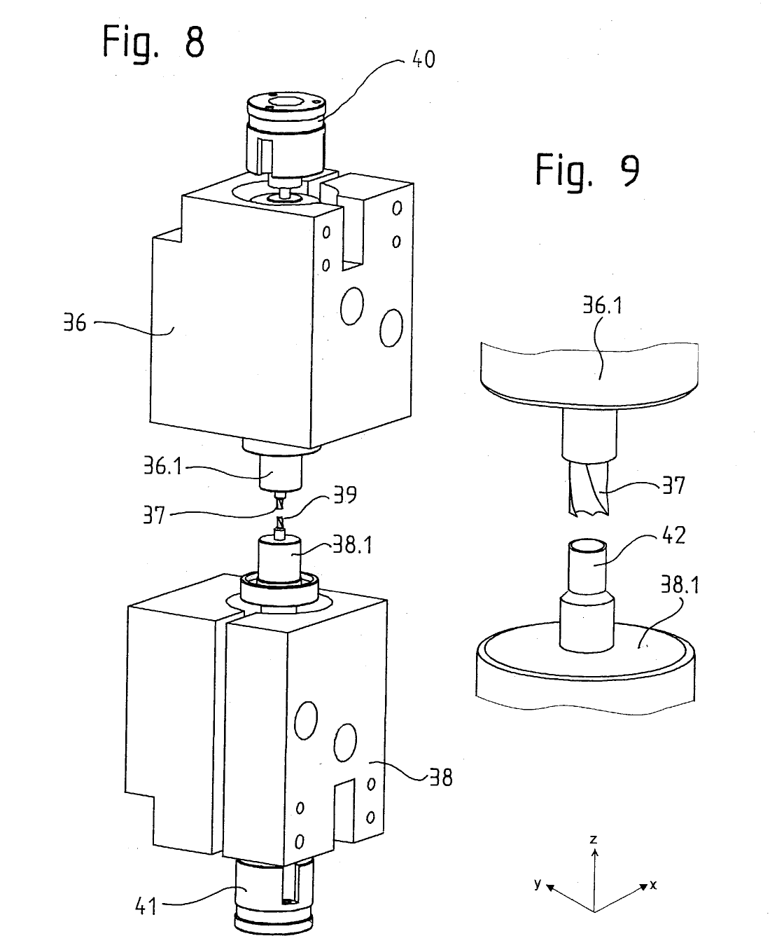

FIG. 8 shows an upper cutting head 36 with a spindle 36.1 and a cutter 37, and a lower cutting head 38 with a spindle 38.1 and a cutter 39. The drive 25 of the upper cutting unit 24 is connected by means of a coupling 40 with the spindle 36.1 and the drive 35 of the lower cutting unit 34 is connected by means of a coupling 41 with the spindle 38.1.

FIG. 9 shows the cutter 37, which is constructed as a face cutter, of the upper cutting head 36. Instead of the cutter 39 of the lower cutting head 38 there is provided a punch 42 which serves, in the region of the upper cutter 37, as a support for the flat cable 1. The cutter 37 and the punch 42 can also be interchanged.

For carrying out, for example, the cut 11, the cutter 37 is moved in the “x” direction and the “y” direction at the start of the cutting and is subsequently lowered in the “z” direction, wherein the rotating cutter 37 removes the insulation 3 in the stripping area. As soon as the bare conductor 2 is detected, the cutter 37 is moved in the “x” direction until the conductor 2 is exposed for a predetermined length. The cutter 37 is then raised again.

The detection of the bare conductor 2 can be carried out, for example, on the principle of electrical continuity, wherein at least one cutter and the bare conductor close a current circuit.

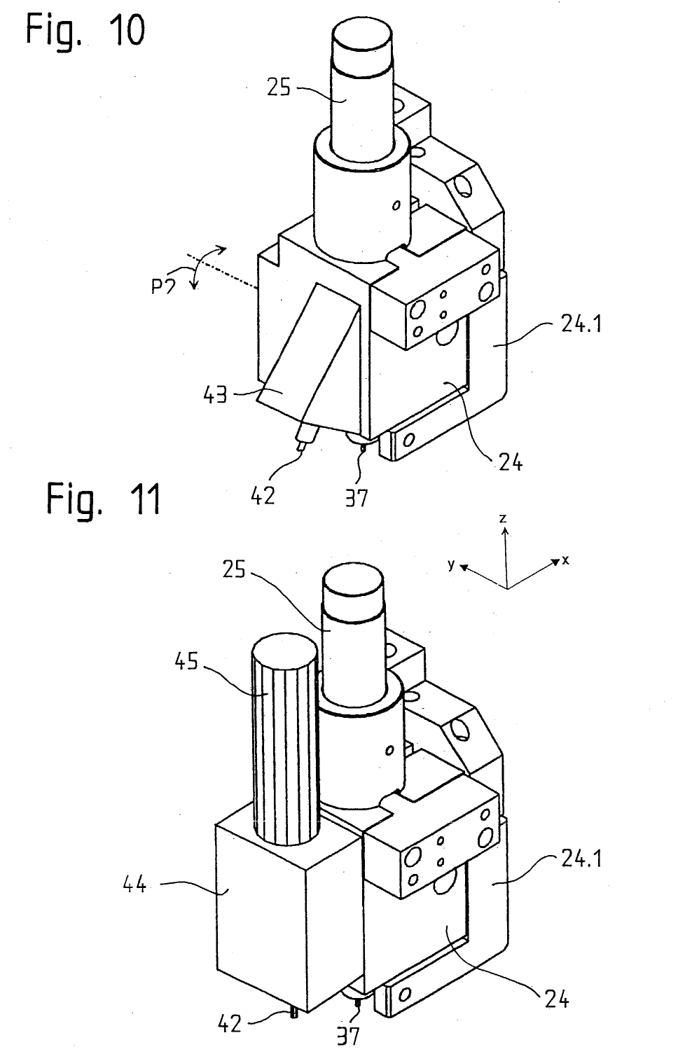

As shown in FIG. 10, the cutting unit 24 (34) can also be provided for an automatic exchange of the cutter 37 (39) or of the punch 42. For example, the cutting unit 24 (34) with the drive 25 (35) can be rotatably arranged at the z-module 26 (32) as symbolized by an arrow P2, wherein the punch 42 is arranged at an arm 43 of the cutting head 36 (38). Depending on the respective working program the spindle 36.1 (38.1) with the cutter 37 (39) or the arm 43 with the punch 42 is rotated into the working position.

FIG. 11 shows a variant of embodiment of the cutting unit 24 (34) with a cutter 37 (39) and the punch 42. A housing 44 is arranged at the cutting unit 24 (34) and serves as a support for a pneumatic cylinder 45 at which the punch 42 is arranged. The pneumatic cylinder 45 moves the punch 42 in the “z” direction. Compensation for the offset between the cutter 37 and the punch 42 is provided by the x-module and/or the y-module.

In accordance with the provisions of the patent statutes, the present invention has been described in what is considered to represent its preferred embodiment. However, it should be noted that the invention can be practiced otherwise than as specifically illustrated and described without departing from its spirit or scope.

What is claimed is:

1. A method of stripping a flat cable having a plurality of conductors embedded in insulation comprising the steps of:
a. holding a flat cable stationary and tensioning the flat cable;
b. providing a mechanical cutting unit with a cutter; and
c. moving the cutting unit predetermined distances in x, y and z directions while operating the cutter to strip the insulation from the flat cable in a predetermined area and expose a selected one of the conductors.

2. The method according to claim 1 including performing said steps b. and c. on at least one of an upper side and an underside of the flat cable.

3. The method according to claim 1 including performing said steps b. and c. on an upper side of the flat cable, providing another mechanical cutting unit with another cutter at the cutting station, and moving the another cutting unit predetermined distances in x, y and z directions while operating the another cutter to strip the insulation from an underside of the flat cable and expose the selected one of the conductors.

4. The method according to claim 1 including moving the cutting unit the predetermined distances in the x, y and z directions while operating the cutter to cut through the selected conductor.

5. The method according to claim 1 including moving the cutting unit the predetermined distances in the x, y and z directions while operating the cutter to cut a cable passage through the flat cable.

6. A cable stripping equipment for stripping a flat cable having a plurality of conductors embedded in insulation, comprising:
means for holding a flat cable under tension; and
a stripping means mounted adjacent said means for holding and including a cutter, said stripping means being operable to move said cutter in x, y and z directions to strip the insulation from the cable in a predetermined area and expose a selected one of the conductors.

7. The equipment according to claim 6 wherein said means for holding orients the flat cable in a generally horizontal plane and said stripping means is mounted to strip the insulation from one of an upper side and an underside of the flat cable.

8. The equipment according to claim 6 wherein said cutter is a face cutter.

9. The equipment according to claim 6 wherein said stripping means includes a punch and means for alternately moving said cutter and said punch to a working position relative to the flat cable.

10. The equipment according to claim 6 wherein said cutter is positioned adjacent one of an upper side and an underside of the flat cable and including a tool movable in the x, y and z directions mounted on an opposite side of the flat cable from said cutter.

11. The equipment according to claim 9 wherein said tool is one of a face cutter and a punch.

12. The equipment according to claim 6 wherein said means for holding includes a pair of cable advancing devices on opposite sides of said stripping means.
